(19) United States
(12) Patent Application Publication
(10) Pub. No.: US 2021/0403213 A1
(43) Pub. Date: Dec. 30, 2021

(54) Combined bottle cap and magnifying glass

(71) Applicant: Shaoyi SONG, Qingdao Development Zone (CN)

(72) Inventor: Shaoyi SONG, Qingdao Development Zone (CN)

(21) Appl. No.: 17/019,363

(22) Filed: Sep. 14, 2020

(30) Foreign Application Priority Data
Jun. 28, 2020 (CN) 202021214124.7

(51) Int. Cl. B65D 51/24

(52) U.S. Cl. CPC B65D 51/24; G02B 25/002

(57) ABSTRACT

A combined bottle cap and magnifying glass, including an outer cap, an inner cap, and a gasket; the inner cap is connected to a bottle body through internal threads; a convex magnifying glass is provided at a center part of the inner cap; the magnifying glass and the inner cap are configured integrally; a first hole corresponding to the magnifying glass is provided on the outer cap; the gasket is provided with a second hole corresponding to the magnifying glass; the outer cap and the inner cap are fastened together; the gasket is arranged between the inner cap and the bottle body; the magnifying glass is fitted to the first hole and the second hole.

### BACKGROUND OF THE INVENTION

The present invention relates to the technical field of storage devices, and more specifically relates to a combined bottle cap and magnifying glass

As kids grow up, they are curious of everything around them. In order to prevent kids from accessing some particular products, such as medicine, a bottle security cap to ensure safety of the kids has been invented. However, after a product is capped by such security cap, especially when the product is also attached with product labels on its surfaces, users are unable to directly observe the contents inside. Only after the cap is opened, the contents can be revealed. However, opening the cap will affect the air-tightness of the product and its sale after repackaging.

A prior art solution is to drill a hole on the cap, customize a magnifying glass of a same size that fits the drilled hole, apply glues on two side surfaces of the magnifying glass, adhere the magnifying glass to the cap, arrange plastic plates at inner sides of the cap to fix the magnifying glass by clamping the magnifying glass between two plastic plates. This method can only adhere the magnifying glass inside the cap, and this method is disadvantageous in its poor sealing effect, easy communication of air inside and outside the cap, large quantity of supplementary components, high cost, low efficiency and long production time.

### BRIEF SUMMARY OF THE INVENTION

In view of the aforesaid disadvantages now present in the prior art, the present invention provides a combined bottle cap and magnifying glass to overcome all the above problems or at least partially overcome the above problems.

According to an aspect of the present invention, the present invention provides a combined bottle cap and magnifying glass, comprising an outer cap, an inner cap, and a gasket; the inner cap is connected to a bottle body through internal threads; a convex magnifying glass is provided at a center part of the inner cap; the magnifying glass and the inner cap are configured integrally; a first hole corresponding to the magnifying glass is provided on the outer cap; the gasket is provided with a second hole corresponding to the magnifying glass; the outer cap and the inner cap are fastened together; the gasket is arranged between the inner cap and the bottle body; the magnifying glass is fitted to the first hole and the second hole.

According to an embodiment, the inner cap and the outer cap are connected by screw threads.

According to another embodiment, an inner top side of the outer cap facing towards the inner cap is provided with first fasteners positioned around the first hole; an outer top side of the inner cap facing towards the outer cap is provided with second fasteners corresponding to the first fasteners; the second fasteners are positioned around the magnifying glass; the first fasteners and the second fasteners are mutually fastened.

According to the present invention, the bottle cap and the magnifying glass are formed integrally. By altering a thickness of the center part of the inner cap, the magnifying glass is directly made on the inner cap in accordance with the principle of configuring magnifying glass. The outer cap is provided with a hole for exposure of the magnifying glass of the inner cap. Accordingly, cost is saved and the product can maintain good air-tightness.

A summary of the technical solutions of the present invention is intended above. In order to understand the technical solutions of the present invention more clearly so that the description herein can be practiced, and in order that the above purposes and other purposes of the present invention, its characteristic features and its advantages can become more obvious and easier to comprehend, an embodiment of the present invention is specifically given below.

### BRIEF DESCRIPTION OF THE DRAWINGS

In order to describe the technical solutions of the present invention more clearly, the drawings required to describe the embodiment of the present invention are briefly introduced below. Obviously, the drawings described below are only the drawings of one of the many possible embodiments of the present invention. A person skilled in this field of art should be aware that other new drawings may be obtained based on the drawings of the present invention on condition that the new drawings can be obtained without any inventive effort.

FIG. 1 is a schematic structural view of the outer cap according to an embodiment of the present invention.

FIG. 2 is a schematic structural view of the outer cap according to an embodiment of the present invention in an alternative angle of view.

FIG. 3 is a partially enlarged view of FIG. 2.

FIG. 4 is a schematic structural view of the inner cap according to an embodiment of the present invention.

FIG. 5 is a schematic structural view of the inner cap according to an embodiment of the present invention in an alternative angle of view.

FIG. 6 is a partially enlarged view of FIG. 5.

FIG. 7 is a schematic structural view of the gasket according to an embodiment of the present invention.

FIG. 8 is a partial sectional view of the present invention.

FIG. 9 is cross sectional view of the combined bottle cap and magnifying glass of the present invention.

Reference numbers in the figures:

Outer cap 1; inner cap 2; gasket 3; first hole 11; first fasteners 12; magnifying glass 21; second fasteners 22; second hole 31.

### DETAILED DESCRIPTION OF THE INVENTION

An exemplary embodiment of the present invention will be further described in detail below with reference to the drawings. Although the drawings illustrate the exemplary embodiment of the present invention, it should be noted that, the present invention can be implemented in various ways and should not be limited to the embodiment described herein. The embodiment is given only to facilitate a more thorough understanding of the present invention and to convey to a person skilled in the art entirely about the scope of the present invention.

The terms “comprise” and “include” and any of their variations appearing in the specification, claims and drawings of the present invention are intended to mean non-exclusive inclusion. For example, additional steps or components may be included.

The technical solutions provided by the present invention will be further described in detail below with reference to the drawings and an embodiment.

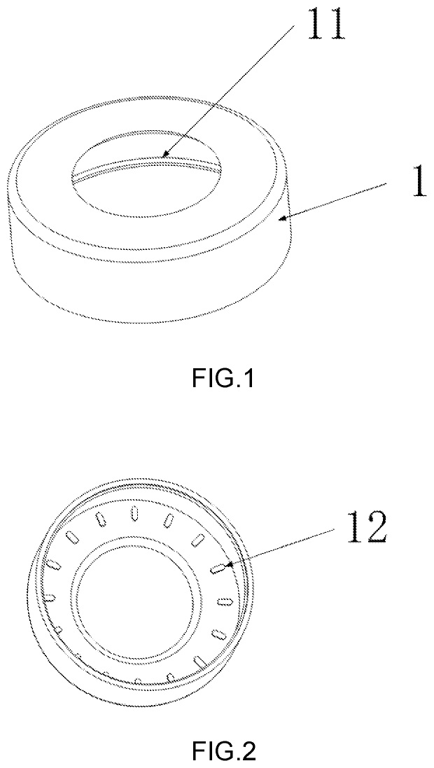

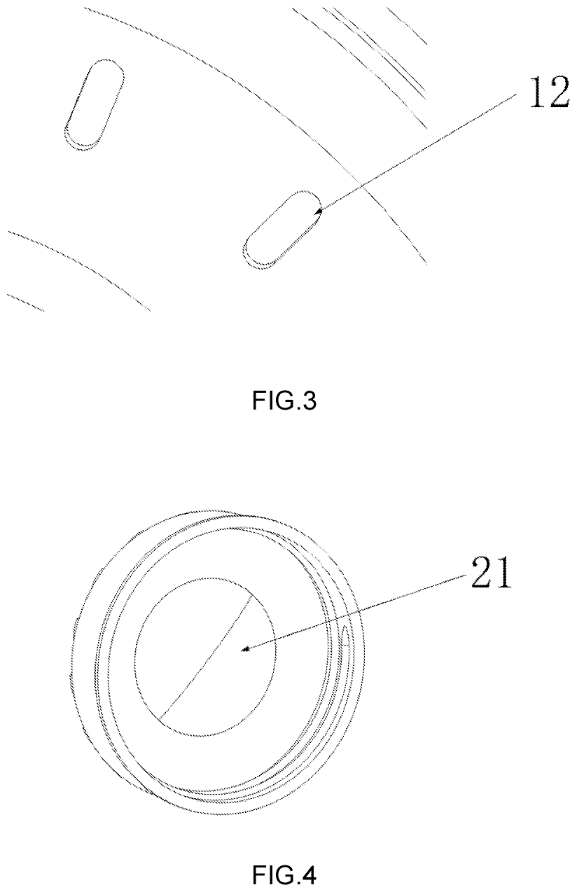

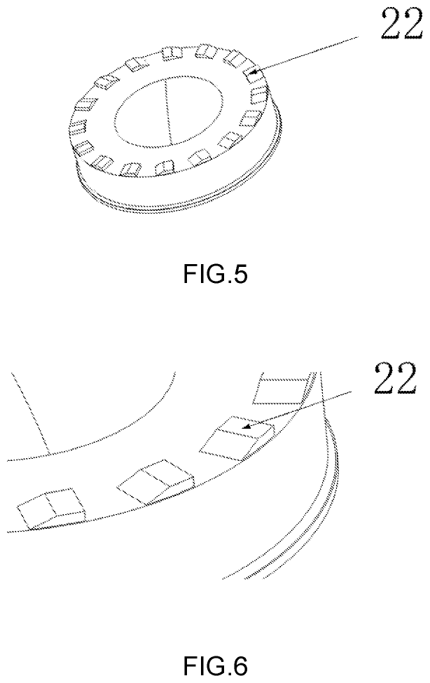

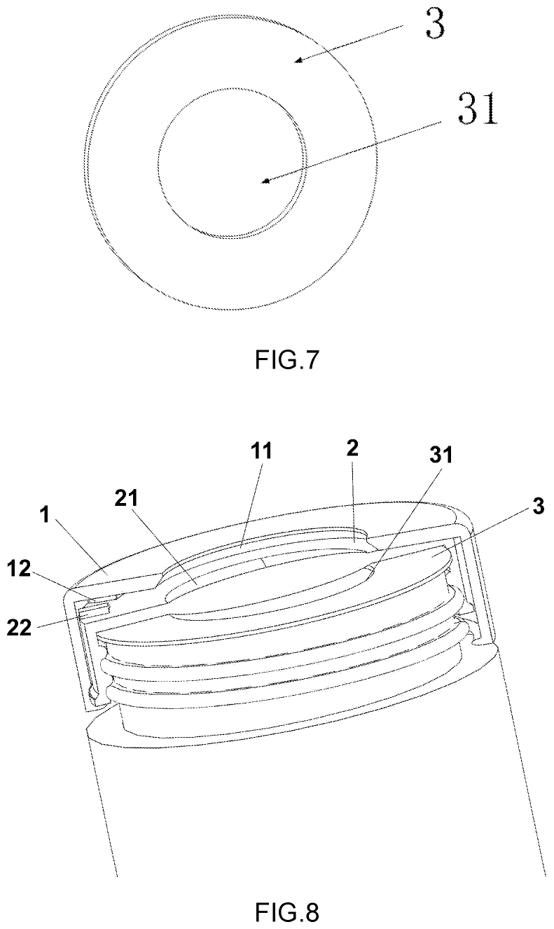

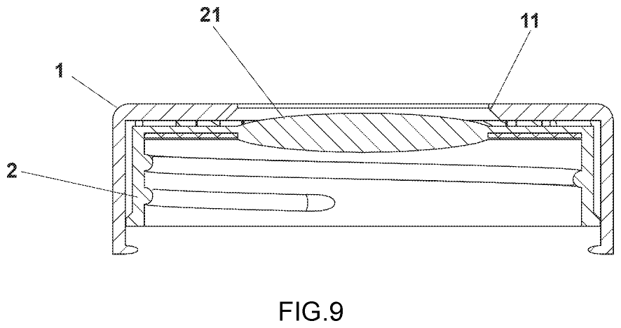

As shown in FIGS. 1-7, the present invention provides a combined bottle cap and magnifying glass, comprising an outer cap 1, an inner cap 2, and a gasket 3.

The inner cap 2 is connected to a bottle body through internal threads. A convex magnifying glass 21 is provided at a center part of the inner cap 2. The magnifying glass 21 and the inner cap 2 are configured integrally.

A first hole 11 corresponding to the magnifying glass 21 is provided on the outer cap 1. The gasket 3 is provided with a second hole 31 corresponding to the magnifying glass 21. The outer cap 1 and the inner cap 2 are fastened together. The gasket 3 is arranged between the inner cap 2 and the bottle body. The magnifying glass 21 is fitted to the first hole 11 and the second hole 31.

According to an embodiment, the inner cap 2 and the outer cap 1 are connected by screw threads.

According to another embodiment, an inner top side of the outer cap 1 facing towards the inner cap is provided with first fasteners 12 positioned around the first hole 11. An outer top side of the inner cap 2 facing towards the outer cap 1 is provided with second fasteners 22 corresponding to the first fasteners 12. The second fasteners 22 are positioned around the magnifying glass 21. The first fasteners 12 and the second fasteners 22 are mutually fastened.

The above detailed description further describes the purposes, the technical solutions, and the beneficial effects of the present invention in detail. However, it should be noted that the description is only intended to describe the detailed way of implementing the present invention, and should not be considered limiting the scope of the present invention. Any changes, modifications and equivalent replacements made in accordance with the spirits and principles of the present invention should also fall within the scope of protection of the present invention.

What is claimed is:

1. A combined bottle cap and magnifying glass, comprising an outer cap, an inner cap, and a gasket;
the inner cap is connected to a bottle body through internal threads; a convex magnifying glass is provided at a center part of the inner cap; the magnifying glass and the inner cap are configured integrally;
a first hole corresponding to the magnifying glass is provided on the outer cap;
the gasket is provided with a second hole corresponding to the magnifying glass; the outer cap and the inner cap are fastened together; the gasket is arranged between the inner cap and the bottle body; the magnifying glass is fitted to the first hole and the second hole.

2. The combined bottle cap and magnifying glass of claim 1, wherein the inner cap and the outer cap are connected by screw threads.

3. The combined bottle cap and magnifying glass of claim 1, wherein an inner top side of the outer cap facing towards the inner cap is provided with first fasteners positioned around the first hole; an outer top side of the inner cap facing towards the outer cap is provided with second fasteners corresponding to the first fasteners; the second fasteners are positioned around the magnifying glass; the first fasteners and the second fasteners are mutually fastened.
